(19) United States
(12) Patent Application Publication
(10) Pub. No.: US 2015/0199705 A1
(43) Pub. Date: Jul. 16, 2015

(54) VOUCHER SYSTEM AND APPARATUS

(71) Applicant: SWIPESTATION LIMITED, Borehamwood, HS (GB)

(72) Inventor: Syd Nadim, Kings Langley (GB)

(21) Appl. No.: 14/414,106

(22) PCT Filed: Jul. 12, 2013
(86) PCT No.: PCT/GB2013/051847

§ 371 Date: Jan. 11, 2015

(30) Foreign Application Priority Data
Jul. 12, 2012 (GB) 1212403.8

(51) Int. Cl. G06Q 30/02; G06K 15/02

(52) U.S. Cl. CPC G06Q 30/0238; G06K 15/02

(57) ABSTRACT

A voucher terminal (102) comprising a scanner (104) for reading data (14) provided on any one or more of a number IN of data-bearing surfaces (20, 142), a processor adapted to interpret the read data (14) and to generate an electronic version of the read data in the form of a standardised voucher (140) containing the read data (14) displayed in a standardised format, a printer for reproducing the standardised voucher (140) in a printed form, and an interface adapted to transmit the electronic version of the read data to a remote data server (42). The voucher terminal (102) is suitably connected to a POS device (30) via a connection with the server (42), and third party data providers (12) are suitably able to produce data-bearing surfaces (20, 142) electronically, on in hard-copy format for presenting, by a user (16) at the terminal (102) for redemption at a POS device (30). The system suitably provides an interconnected system whereby third party providers (12) are able to interact with users (20), and whereby users (16) are able to redeem vouchers (20, 142) at POS devices (30) and for the POS (30) to reconcile redemption with the voucher terminal (102), server (42) and third party providers (12) more efficiently. The invention also facilitates voucher distribution and redemption via multimedia and social media.

### DESCRIPTION

This invention relates to a voucher system and apparatus, and in particular, to system and apparatus for voucher and/or coupon redemption.

Coupon or voucher schemes are very well-known in the retail industry and have become an established way to build relationships with customers and to market new products and services. Conventionally, a retail voucher scheme entails a user or customer obtaining a voucher or coupon in return for supplying information to a product or service provider. Many supermarket and retail chains operate loyalty reward schemes whereby customers can identify themselves at the point of sale (POS) using a unique identifier, such as a coded loyalty card, that enables the retailer to tie customers to purchases and thus build-up a picture of individual customer's purchasing habits. In return, the customer often receives a small percentage discount off future purchases, and/or coupons appended to the POS receipt with individual product or service offers that can be redeemed at a later date.

Other examples of a voucher/coupon scheme involve distributing coupons or vouchers via e-mail, post or on product packaging, which customers can present at a POS to receive a discount. By the use of promotional codes, date stamping and POS location data, such schemes enable retailers to link specific purchases to particular advertising schemes to determine where and when customers respond to the offer and the delay in redemption.

Coupon and voucher schemes can provide retailers with important consumer statistics, which can help them to develop better products, gain market share, raise brand awareness and establish a relationship with customers.

Unfortunately, many voucher/coupon schemes, in particular, paper-based schemes, are expensive and time-consuming to implement, can provide unreliable feedback and can be unacceptably susceptible to fraud. For example, unless each voucher is unique, it is theoretically possible to copy or re-print a paper-based voucher and for a customer to present it several times for redemption. Also, unless voucher use is logged centrally in real-time, it is possible for a customer to re-use a voucher several times before its first use is detected by the retailer and subsequent uses blocked.

One retail sector were voucher fraud is commonplace is in the bar/restaurant industry where customers are likely to make several purchases in a short time period. Often, customers can use a copy of a voucher several times in one day because the voucher use is not logged until the end of each day, especially in busy establishments.

Another problem with existing voucher/coupon schemes is their often disjointed nature, that is to say, lack integration between different media streams, such as social media, which represents a potential loss of opportunity.

This invention aims to provide a solution to one or more of the above problems and/or to provide an improved/alternative voucher/coupon system and apparatus.

According to a first aspect of the invention, there is provided a voucher terminal device comprising a scanner for reading data provided on any one or more of a number of data-bearing surfaces, a processor adapted to interpret the read data and to generate an electronic version of the read data in the form of a standardised voucher containing the read data displayed in a standardised format, a printer for reproducing the standardised voucher in a printed form, and an interface adapted to transmit the electronic version of the read data to a remote data server.

Preferably, the scanner comprises a scanner or camera, such as a web cam device, for reading a code, such as a 1D or 2D barcode, a smartcode or a QR code (hereinafter, a “code”).

The standardised voucher containing the electronic version of the read data may be in any suitable form, such as a portable document format file, an XML file, a text file or an HTML file that can be readily transmitted to the data server, and which is preferably readable by a wide range of devices.

The printer of the voucher terminal device may comprise a laser, inkjet or thermal printer, although a thermal printer is preferred as it avoids the need for ink/toner replenishment, and enables the paper used to be more readily controlled.

The interface for connecting the voucher terminal to the remote data server may be a wired or wireless network interface, may comprise a modem or a router and/or a telephone or internet connection.

The voucher terminal preferably also comprises a computing device for controlling its operation, and may additionally comprise a user interface, such as a screen and keyboard/keypad and/or a touch screen interface.

According to a second aspect of the invention, there is provided a voucher terminal comprising: means for outputting a data-bearing voucher upon detection of a user input and an interface for interfacing the voucher terminal with a data server, the data being adapted to record and collate data about the outputted data-bearing vouchers.

According to a third aspect of the invention, there is provided a voucher system comprising: a voucher terminal comprising means for outputting a data-bearing voucher upon detection of a user input; a POS terminal comprising means for reading the data on the said voucher and redeeming the voucher by executing an action based on the data read; wherein the voucher terminal and POS terminal are each operatively connected to a data server, the data server being adapted to record and collate data about the outputted data-bearing vouchers and the redemption of the vouchers by the POS terminal.

Advantageously, the system of the invention may enable the generation and redemption of vouchers to be linked by date, time, location, user, venue and by other means, thereby providing direct feedback on the use of vouchers or coupons. Further, the invention can automate the process of voucher generation and redemption in a secure manner, thereby affording the potential to reduce the amount of human input required to operate a voucher scheme, which could reduce errors and help to avoid duplication of effort, resources and fraud. Additionally, the invention may enable the system to be integrated, via the data server, with other hardware and/or software systems thus enabling sharing of data between different systems.

The voucher system preferably comprises a wired or wireless network for operatively connecting one or more voucher terminals and one or more POS terminals to one or more data servers. The wired network, where provided, may comprise a wired Local Area Network (LAN) and the wireless network, where provided, may comprise a Wireless Local Area Network (WLAN). The network of the voucher system may comprise a wired or wireless data or internet connection for operatively interconnecting voucher terminals, POS terminals and data servers located at different physical, or virtual locations.

Each of the voucher terminals, POS terminals and data servers preferably comprises a network interface to enable it to operatively interconnect with other devices on the system.

The voucher terminal comprises means for outputting a data-bearing voucher, which may take the form of a paper ticket bearing a printed code that is readable by a suitable scanner or camera device of the POS terminal. Additionally or alternatively, the voucher terminal may comprise a processor for generating a machine-readable code that is displayable on the screen of a user's portable computing device. In a preferred embodiment of the invention, the voucher terminal interfaces with an internal, or web-based, mobile telephony device for sending an SMS message or multimedia message to the mobile telephone of a user, which message comprises a code that can be displayed on the screen of the mobile phone, which code can be scanned and read by a scanner of the POS terminal.

User inputs may be detectable by the scanner, or by other means, such as by tapping an area of a touch screen or a button of the voucher terminal or Bluetooth® or Near Field Communications (NFC), by detecting the proximity of a user, etc.

Additionally or alternatively, the voucher terminal comprises a processor adapted to send an e-mail message to a user's e-mail address, which e-mail comprises a code that can be printed and scanned by the POS terminal, and/or which can be displayed on the screen of a user's mobile telephone or other portable computing device, whereupon it can be read by a suitable scanner of the POS terminal.

The POS terminal may comprise a scanner for reading the machine-readable code of a data-bearing voucher.

The data server preferably comprises a web-based user interface that users, or potential users, of the system can access via individual user login details. The data server preferably comprises a database of users and user details. The user details can comprise personal details, contact information and other relevant information. The data server preferably comprises a database of user information, which links user accounts and details to external account data, such as social media accounts (e.g. Facebook®, Twitter®, LinkedIn®, Google+®, etc. accounts) according to social media account details provided by users of the system. Accordingly, the invention is able to integrate e-mail, SMS, postal, social media and other advertising campaigns effectively using a central database of inter-related data for registered users and potential users of the system.

Preferred embodiments of the invention shall now be described, by way of example only, with reference to the accompanying drawings in which:

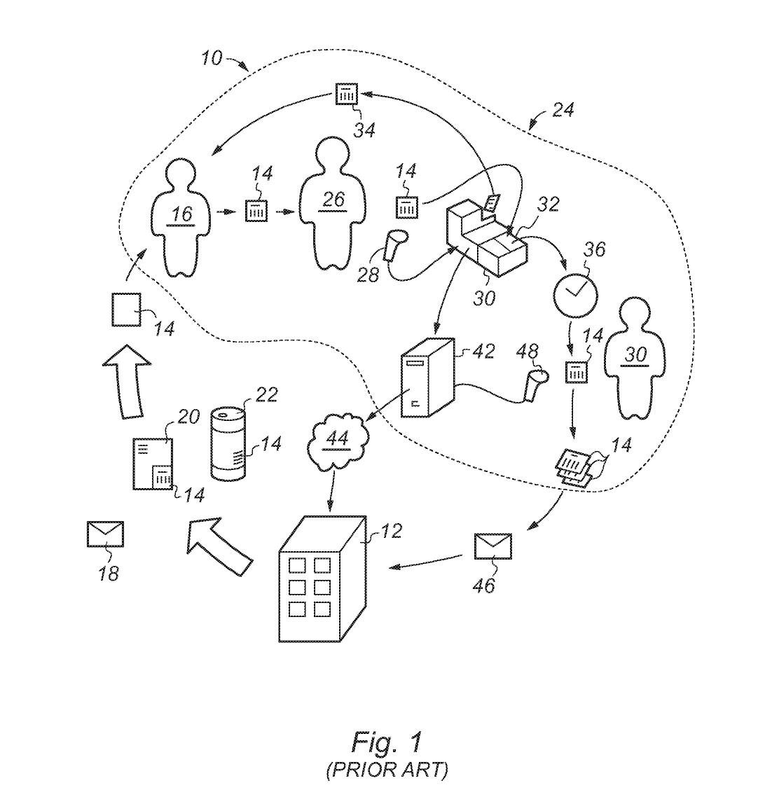

FIG. 1 is a schematic diagram showing the operation of a known voucher system;

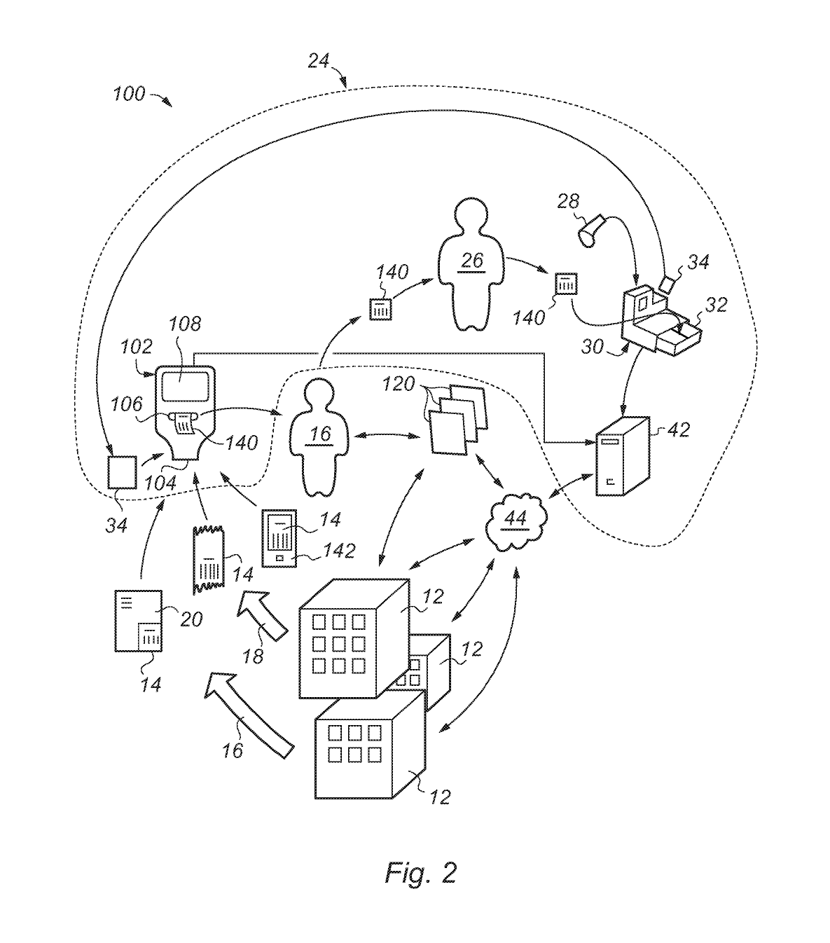

FIG. 2 is a schematic diagram showing the operation of a voucher system in accordance with the invention;

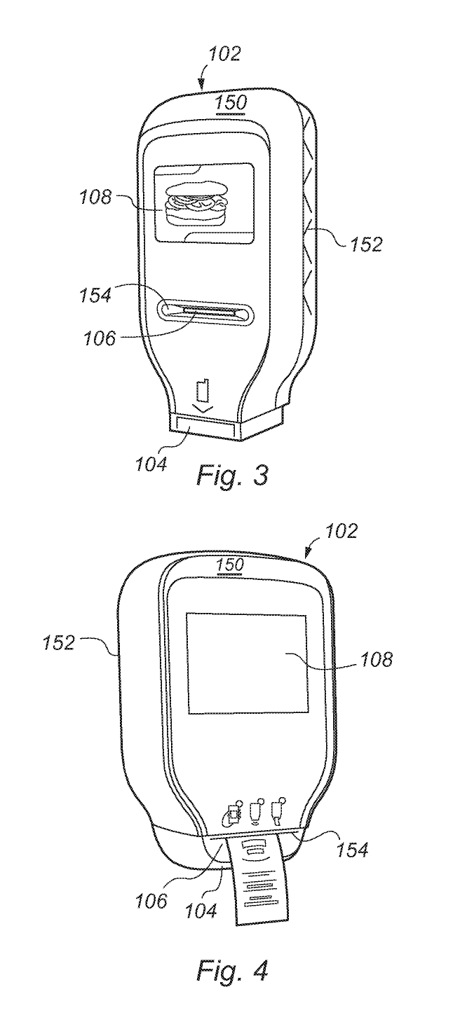

FIG. 3 is a perspective view of a first embodiment of a voucher terminal in accordance with the invention; and

FIG. 4 is a perspective view of a second embodiment of a voucher terminal in accordance with the invention.

A known voucher system 10 is shown in FIG. 1, in which a voucher scheme provider 12 offers vouchers or coupons 14 to customers 16 via post 18, e-mail 20 or attached to product packaging 22. A customer 16 can thus obtain a voucher 14 from a scheme provider 12 for redemption at a retail establishment 24.

When the customer 16 decides to use the voucher 14, he or she visits a participating retail establishment 24 and presents the voucher 14 to a teller 26 at the time of making a purchase. The teller 26 also has the option to scan the voucher 14 using a scanning device 28 associated with an EPOS till 30 and places the voucher 14 in the till drawer 32. More usually, however, the teller needs to key-in a sequence of codes on the EPOS device to register the voucher redemption, which can add significantly to the amount of time it takes to serve each customer.

The EPOS till 30 is configured to apply a discount to products purchased by customers 16 presenting vouchers 14, and display the discount applied on a till receipt 34 that is returned to the customer 16 after completing the purchase. A duplicate till roll (not shown) is stored inside the EPOS till 30.

At the end of each shift 36, a manager 30 removes the collected vouchers 14 from each of the EPOS till drawers 32 and scans them again using a voucher scheme provider's scanner 40. At this point, the EPOS log and the manager's log of voucher redemptions can be reconciled using a local computer system 42, and any discrepancies investigated.

The local computer system 42 is configured to manage the cash accounting and inventory control of the participating retail establishments 24, but also has an internet connection enabling reconciled voucher redemption data to the returned to the voucher scheme provider 12 via the internet 44. As a double-check, the original vouchers 14 can also be posted 46 back to the voucher scheme provider 12 for verification and fraud detection purposes.

It will be appreciated that the known system 10 requires several manual user interventions which have the potential to be error-prone and open to abuse. Also, there may be a considerable delay between the issuance of a voucher and its redemption, and there is no easy way to confirm that the intended recipient of the voucher is the same person as the person who redeems it, nor is there any way to guarantee that the voucher is authentic, or whether it is a re-print or copy of an original.

A further significant problem with existing voucher scheme systems, such as that shown FIG. 1 is that the vouchers themselves 14 may come in different physical forms, such as a tear-off portion of the till receipt, a cut-out section from a newspaper or product packaging, a black and white computer print-out, a colour printout, etc. These differences can lead to teller 26 uncertainty at the point of sale, which can introduce unacceptable delays in service times. Also, due to the physical differences in vouchers, it can be difficult to store them in one place (i.e. an A4-sized sheet in the till drawer 32), which can lead to loss of vouchers or irregularities in the EPOS record of redemptions and that stored on the voucher scheme provider's computer 42.

It will be appreciated that any significant increase in service time can have a detrimental effect on a participating retail establishment's 24 cash flow and turnover. This is especially noticeable, say in bars during busy periods, when customers may be queuing four or five deep at the bar to be served. Any way to standardise the vouchers 14 and to move the voucher redemption process away from the EPOS is beneficial to the participating retail establishment and alleviates possible health and safety issues in the service area.

The invention, as shown in FIGS. 2, 3 and 4, provides a solution to one or more of the problems outlined above.

In FIG. 2, it will be seen that the known voucher scheme 10 has been modified 100 by the addition of a voucher terminal device 102. The voucher terminal device 102 comprises a scanner 104, a built-in printer 106 and an optional touch screen display 108. A user is able to create a standardised voucher 140 using the voucher terminal device 102 by scanning an original voucher 14 issued by the voucher scheme provider 12 and receiving a standardised voucher 140 in return having a pre-set layout, size and format that can be presented to the teller 26 during a purchase.

One of the possible advantages of the invention is that it enables teller uncertainty to be considerably reduced because the teller 26 only needs to be trained to recognise and accept one type of voucher, namely the standardised voucher 140, rather than a number of different voucher types.

In addition, the voucher terminal device 102 may be configured to print different versions of standardised vouchers 140, for example, having different background colours or icons on different days or associated with different offers, so that the tellers 26 can easily recognise out-of-date vouchers 140, or identify vouchers requiring special attention, such as relating to age-restricted purchases.

Further, by providing a standardised voucher 140, storage of the vouchers 140 in the EPOS drawer 32 is greatly facilitated, which can lead to reduced redeemed voucher loss and/or misplacement.

A further advantage of the invention is that it enables a user 16 to interact with the voucher scheme provider 12 electronically and to receive vouchers electronically, for example, as a picture attachment to an MMS or SMS message. This facility enables a user 16 to receive vouchers 14 electronically on his or her portable computing device 142 (mobile telephone, tablet PC, laptop computer, etc.), and to exchange the e-voucher 141 for a standardised voucher 140 via the voucher terminal 102.

It will be noted that the voucher terminal 102 is connected to the voucher scheme provider's server and potentially the retail establishment's EPOS device via a network connection 110, enabling data about the generation and redemption of standardised vouchers to be correlated. Advantageously, the voucher terminal device 102 can be located away from the main service area of a retail establishment 24. This means that any delays caused by voucher errors and discrepancies happens away from the main service area, and only affects users of the voucher scheme, rather than holding-up service for other customers.

To encourage participation in the voucher scheme, the till receipt 34 produced by the EPOS device 30 could additionally contain a code that can be scanned by the voucher terminal 102 in return for another standardised voucher 140 that can be redeemed during a subsequent purchase. Such a system affords the possibility of readily introducing a game aspect into retail transactions so that users 16 are encouraged and incentivised to continue to use the voucher scheme.

The above aspects of the invention are particularly facilitated by the use of a central data server 42 interposed between the voucher terminal 102, the EPOS device 30 and the voucher scheme provider 12, which enables the generation and redemption of vouchers to be closely monitored.

A further aspect of the invention that may be particularly advantageous, and which is facilitated by the use of a data server 42, is the ability to allow customers to interact with the retail establishment 24 and the voucher scheme provider 12 online and via social media 120. This is possible because the hardware elements of the system 100, that is the voucher terminal 102 and the data server 42 are operatively connected to the internet 44, which enables customers 16 to interact with the retail establishments 24 (and thus also with the retail establishment's suppliers) and the voucher scheme provider 12 (and its suppliers) via social media 120. This joined-up approach facilitates the sharing of data between customers 16, service 24 and product providers 12.

Finally, FIGS. 3 and 4 are perspective views of two similar types of wall-mountable voucher terminal 102 in accordance with the invention. The voucher terminal 102 comprises a main housing 150 that conceals its inner workings. The voucher terminal 102 has an optional touch screen interface 108, which can be used for displaying relevant information about vouchers, promotions, etc., or during “idle” periods, marketing and advertising media in the form of images and videos. The terminal 102 preferably has built-in speakers 152 enabling music, voice prompts and other sounds to be sent to users of the system to facilitate its use and/or to draw attention to its presence in a retail establishment 24.

The voucher terminal comprises a built-in printer 106 that is configured to print standardised vouchers 140 and to deliver them to customers 16 via a slotted aperture 154 in the front of the housing (FIG. 3) or at the base of the housing (FIG. 4). Underneath the voucher terminal 102, there is provided a scanning device 104, which is configured to read text, 1D and 2D barcode data positioned in its line of sight. A customer 16 can thus place his or her mobile phone showing a 1D or 2D barcode or a paper voucher underneath the scanner, and receive a standardised voucher 140 in return.

The voucher terminal 102 is connected to the data server and to the internet, and upon detection of a user, for example, when a code is placed below the scanner, the voucher terminal interrogates the database for possible matches. For example, if a unique voucher corresponding to an individual user is detected, the then display screen could be configured to display a personalised greeting message identifying the customer by name, avatar or other identifier. This provides a personalised feedback to customers. In addition, customers may be then able to go online to interact with their social media account, a voucher scheme provider's website, the retail establishment's web site (or their respective data server portals) to search for further offers, vouchers or promotions. The system enables customers to obtain standardised vouchers 140 from any one or more of a number of voucher scheme providers that are participating in complementary schemes.

In one particular example, a retail establishment such as a bar chain, may be running a promotion for a particular manufacturer of alcoholic drinks. Customers 16 could obtain vouchers 14 from the alcoholic drinks manufacturer (the voucher scheme provider 12) via online 20, postal 18, newspaper or other media outlets. A customer 16 may, however, be able to upgrade the voucher 14 by redeeming it at a voucher terminal 102 located within one of the voucher schemes provider's 12 preferred retail establishments 24. In this example, the customer 16 may be able to obtain a promotional offer from the retail establishment itself 24, or from another provider, in this case, say, a manufacturer of mixers to accompany the alcoholic beverage. When the customer 16 redeems the standardised voucher 140, the retail establishment 24 is able to report that redemption instantly to the voucher scheme provider(s) 12 in return for its own discounts. The retail establishment 24 and the voucher scheme providers 12 are also able feedback directly to individual customers 16 via text messaging, e-mail, social media etc. to “thank” them for their purchase by, for example, providing further related or similar vouchers.

The invention is not restricted to the details of the foregoing embodiments, which are merely exemplary of the invention. For example, the configuration of the network, the routing of data, the configuration of the voucher terminal etc. could all be changed without departing from the scope of the invention.

1. A voucher terminal comprising a scanner for reading data provided on any one or more of a number of data-bearing surfaces, a processor adapted to interpret the read data and to generate an electronic version of the read data in the form of a standardised voucher containing the read data displayed in a standardised format, a printer for reproducing the standardised voucher in a printed form, and an interface adapted to transmit the electronic version of the read data to a remote data server.

2. A voucher terminal comprising: means for outputting a data-bearing voucher upon detection of a user input and an interface for interfacing the voucher terminal with a data server, the data being adapted to record and collate data about the outputted data-bearing vouchers.

3. A voucher terminal according to claim 1 or claim 2, further comprising a user interface.

4. A voucher terminal device according to claim 3, wherein the user interface comprises a touch screen.

5. A voucher terminal as claimed in any of claims 1 to 4, further comprising a speaker.

6. A voucher terminal device according to any preceding claim, wherein the scanner comprises any one or more of the group comprising: a 1D barcode scanner, a 2D barcode scanner, a camera, a web cam, a smartcode scanner and a QR code scanner.

7. A voucher terminal device according to claim 6, wherein the scanner is located beneath the device.

8. A voucher terminal device according to any preceding claim, wherein the standardised voucher containing the electronic version of the read data comprises any one or more of the group comprising: portable document format file, an XML file, a text file and an HTML file.

9. A voucher terminal device according to any preceding claim, wherein the printer comprises a thermal printer.

10. A voucher terminal as claimed in claim 9, wherein the printer is configured to print standardised vouchers and to deliver them to customers via a slotted aperture in the front of the housing.

11. A voucher terminal according to any preceding claim, wherein the interface for connecting the voucher terminal to the remote data server comprises a wired or wireless network interface or an internet connection.

12. A voucher system comprising: a voucher terminal comprising means for outputting a data-bearing voucher upon detection of a user input; a POS terminal comprising means for reading the data on the said voucher and redeeming the voucher by executing an action based on the data read; wherein the voucher terminal and POS terminal are each operatively connected to a data server, the data server being adapted to record and collate data about the outputted data-bearing vouchers and the redemption of the vouchers by the POS terminal.

13. A voucher terminal system comprising a voucher terminal and a POS device, the voucher terminal comprising a scanner for reading data provided on any one or more of a number of data-bearing surfaces, a processor adapted to interpret the read data and to generate an electronic version of the read data in the form of a standardised voucher containing the read data displayed in a standardised format, a printer for reproducing the standardised voucher in a printed form, and an interface adapted to transmit the electronic version of the read data to a remote data server, and the POS terminal comprising means for reading the data on the said voucher and redeeming the voucher by executing an action based on the data read; wherein the voucher terminal and POS terminal are each operatively connected to the data server, the data server being adapted to record and collate data about the outputted data-bearing vouchers and the redemption of the vouchers by the POS terminal.

14. A voucher system according to claim 12 or claim 13, comprising a voucher terminal according to any of claims 1 to 11.

15. A voucher system as claimed in any of claims 12 to 14, wherein the data-bearing vouchers comprise paper tickets bearing a printed code, which code is readable by a scanner or camera of the POS terminal.

16. A voucher system as claimed in any of claims 12 to 15, wherein the data-bearing vouchers comprise electronic images of codes and wherein the system comprises a processor for generating the said electronic images and for transmitting them to computing devices.

17. A voucher system as claimed in claim 16, wherein the processor is adapted to generate and send an e-mail to one or more designated e-mail addresses, said e-mail or e-mails containing the said electronic image or images.

18. A voucher system as claimed in claim 16, wherein the processor is adapted to generate and send an SMS or multimedia text message to one or more designated mobile telephone numbers, said SMSs or multimedia text messages containing the said electronic image or images.

19. A voucher system as claimed in any of claims 16 to 18, wherein the processor is associated with the voucher terminal.

20. A voucher system as claimed in any of claims 16 to 18, wherein the processor is associated with the data server.

21. A voucher system according to any of claims 12 to 20, wherein the data server comprises a web-based user interface that users, or potential users, of the system can access via individual user login details.

22. A voucher system according to any of claims 12 to 21, wherein the data server comprises a database for storing user details, the user details comprising any one or more of the group comprising: personal details, contact information, user accounts details and links to user's social media accounts.

23. A voucher system according to any of claims 12 to 22, wherein the data server and voucher terminal are connectable to voucher scheme provider's server and/or to a retail establishment's EPOS devices via one or more network connections.

24. A voucher system according to any of claims 12 to 23, wherein the voucher terminal device is located remotely from a main service area of a retail establishment.

25. A voucher system according to any of claims 12 to 24, wherein the POS terminal is configured to print till receipts comprising standardised voucher portions that are redeemable during a subsequent purchase.

26. A voucher system according to any of claims 12 to 25, wherein the POS terminal is configured to print till receipts comprising standardised voucher portions that are readable by the scanner of the voucher terminal.

27. A voucher terminal or voucher system substantially as hereinbefore described, with reference to, and as illustrated in, FIGS. 2 and 3 of the accompanying drawings.
